(19) United States
(12) Patent Application Publication
(10) Pub. No.: US 2017/0073927 A1
(43) Pub. Date: Mar. 16, 2017

(54) PORTABLE TRENCHING DEVICE

(71) Applicants: Peter Blundell, Vancouver, WA (US); Mike Smith, Warkworth (NZ)

(72) Inventors: Peter Blundell, Vancouver, WA (US); Mike Smith, Warkworth (NZ)

(21) Appl. No.: 15/132,776

(22) Filed: Apr. 19, 2016

Related U.S. Application Data
(60) Provisional application No. 62/219,024, filed on Sep. 15, 2015.

(51) Int. Cl. E02F 5/02; B28D 1/08

(52) U.S. Cl. CPC E02F 5/02; B28D 1/082

(57) ABSTRACT

A trenching device rotating a trenching chain through a substrate to form a trench. The trenching device including a power unit, a drive unit including a belt drive system, and a trenching unit including a trenching chain and configured to rotate the trenching chain about a trenching bar.

### RELATED APPLICATION

This application claims the benefit of U.S. Provisional Application No. 62/219,024 filed Sep. 15, 2015, the contents of which are herein incorporated by reference.

### BACKGROUND

Trenching is a process often used when burying lengths of an item or system, such as cables or pipes, in a soil substrate. With the advent of power tools, the laborious process of manual trenching has been simplified. However, often the trenching machines are large, vehicle mounted systems. Many cases, such as sprinkler installation and the laying of buried cables, require only a narrow trench to be dug. The use of large trenching machines to form these small trenches is often inefficient. Further, the large trenching machines can be destructive in their own right just by moving, often destroying existing landscaping and compacting adjacent soil. Also, due to their size, traditional trenching machines can be difficult to maneuver in tight quarters and around existing structures.

There exists a need for a compact, portable trenching device that is suitable for use in forming narrow trenches.

### BRIEF DESCRIPTION OF THE DRAWINGS

FIG. 1 is an example trenching device.

FIG. 2 is an exploded view of an example trenching chain mounting system.

FIG. 3 is an exploded view of an example trenching chain mounting system and chain bar.

### SUMMARY OF THE INVENTION

The disclosed invention provides a portable, single-user trenching device. The trenching device contains an engine that drives a trenching chain that can be rotated through a substrate to form a trench. The trenching device is further configured for ease of use, minimizing kickback of the device and vibrations transmitted to a user during use. These characteristics assist in decreasing user fatigue, increasing user safety and enhancing durability of the device.

### DETAILED DESCRIPTION

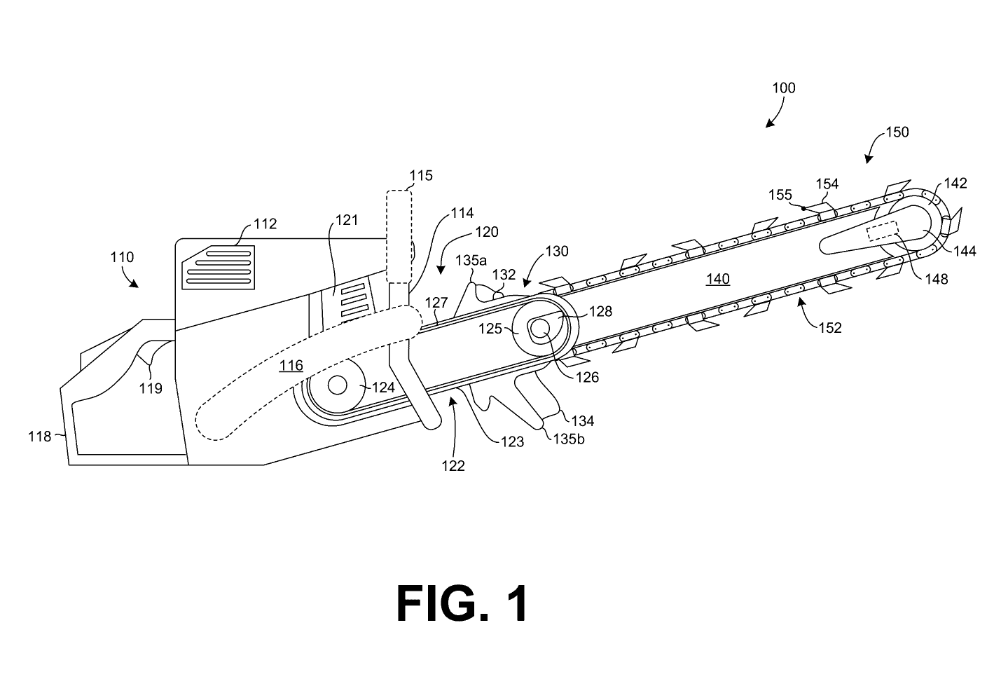

An example trenching device 100 is shown in FIG. 1 and includes a power unit 110, a drive unit 120, a mounting attachment 130, a trenching bar 140 and a trenching unit 150. The power unit 110 supplies motive power to the trenching unit 150, causing the trenching chain 152 to rotate about the trenching bar 140. As the trenching chain 152 is drawn about the trenching bar 140, the teeth 154 of the trenching chain 152 dig into the substrate and excavate material.

The trenching device 100 is a small, portable, single-user trenching tool, which allows a user to dig a trench through a substrate material. A user can hold the trenching device 100 in their hands, or alternatively, the device 100 can be placed on a wheeled cart during trenching operations.

The power unit 110 includes a top handle 114 and a rear handle 118 which can be grasped by a user to control and move the trenching device 100. The rear handle 118 includes a throttle control 119 which can be manipulated by the user hand on the rear handle 118. In the example shown, the throttle control 119 is a spring action type trigger control which is connected to an engine 121 by a throttle linkage. The rear handle 118 is ergonomically shaped for user's grip and comfort. Additional grip comfort considerations can be included, such as a foam or gel pad that can provide cushioning for the user's grip and also reduce device 100 vibrations transmitted to the user.

The top handle 114 is connected to the base of the power unit 110 and to an optional support arm 116. In the example of FIG. 1, the top handle 114 is formed of bent metal tubing. The top handle 114 can be connected to the base of the housing directly, such as by a screw, or placing and/or securing the ends of the handle in openings or recesses of the power unit 110. The top handle 114 can also be mounted in a vibration minimizing manner in order to minimize vibrations transmitted to a user through the handle 114. Such mounting means can include mounting the ends of the handle 114 in recesses or holes within the power unit 110 and allowing the ends of the handle 114 to freely rotate within the recesses and/or holes. This freedom or rotation allows the top handle 114 to rotate forward and backward relative to the trenching device 100. Torsion springs can be included about the handle ends and engaged with the power unit 110. The torsion springs allow independent movement of the two elements, the power unit 110 and handle 114, relative to each other while also dampening said movement. The damped motion can limit the amount of relative movement between the handle 114 and the trenching device 100, further helping to absorb vibrations and limit the amount of transmitted vibration to a user.

In another example, the mounting system of the top handle 114 can include placing the ends of the handle 114 in spherical bearings mounted within the power unit 110. The spherical bearings allow a limited range of motion for the handle 114 in multiple planes. Allowing controlled or buffered motion in multiple planes can assist in reducing transmitted vibrations.

In a further example, the mounting system of the top handle 114 can include attaching the handle to the power unit 110 by a pliable material, such as rubber bushings in which the ends of the handle 114 are attached to the power unit 110. The pliable nature of the material will absorb and reduce the vibrations transmitted through the handle to the user. The reduction of vibration experienced by the user can reduce user fatigue which can increase user efficiency and safety.

The top handle 114 can also include a cushioned grip 115 about an upper portion that would be grasped by a user. The cushioned grip 115 provides user comfort and can also assist in lessening or minimizing the vibrations experienced by a user.

An optional support arm 116 further connects and braces the top handle 114 to the power unit 110. Due to its positioning on the machine, through the top handle 114 is where the user will support the bulk of the trenching device 100. Also, the top handle 114, serves as a pivot, at approximately the center of gravity, about which the device can balance. The support arm 116 further braces and supports the top handle 114 due to the loading that the handle 114 can experience.

In an example embodiment, the support arm 116 can be connected to the power unit 110 and the top handle 114 using a pin-type connection. A pin-type connection allows rotation of the elements relative to each other in a plane orthogonal to the pin-type connection. This degree of freedom allowed by the pin-type connection can help reduce transmitted forces to the user, reducing user fatigue. The combined use of this connection type with a pliant material used to construct support arm 116, can further reduce the vibration and/or kickback transmitted through the handle 114.

The power unit 110 also includes an air filter 112 through which air is drawn into the engine 121. During trenching operations, dust and substrate material can be released into the air. The air filter 112 prevents particulates from the surrounding air from entering the engine 121 during the combustion process. The prevention of particulate entry can reduce wear and maintenance requirements and also increase the efficiency of the engine 121. The air filter 112 should have sufficient surface area and porosity to allow adequate air flow into the engine 121 while still screening out particles of the size that may be encountered during trenching of the substrate. The filter is preferably a multi-stage type filter system as typically found in use with internal combustion engine intakes. The multi-stage type filter system can include a cyclonic action, a foam filter and a paper and/or felt filter element(s). Alternatively, the filter system can be a singular type element, such as a foam, felt or paper-type filter element.

The air filter 112 is removable and replaceable, allowing the user to quickly and easily replace and/or clean the air filter 112 as necessary. Additionally, if a substrate has very fine particles, the standard air filter 112 can be replaced with one having reduced filter openings that can sufficiently remove a reduced size of particulate from the incoming airstream. The finer air filter 112 can reduce engine 121 performance due to restricted airflow through the reduced filter opening size and/or from clogging of the filter openings. The ability to interchange the air filter 112 is desirable as the finer filter can be used only in situations where necessary.

The drive unit 120 includes an engine 121 and drive arm 122, which generate and transmit power to the trenching unit 150. The drive unit 120 can be mounted to, or in, the power unit 110 and is preferably mounted to isolate vibration and kickback from the drive unit 120 into the power unit 110. Minimizing vibration and kickback transmitted from the drive unit 120 to the power unit 110 can assist in reducing the amount of fatigue experienced by the user. The less fatigued the user is, the longer they can operate the trenching device 100 and the more safely the device can be operated.

The drive unit 120 can be mounted to, or in, the power unit 110 using a number of vibration minimization and/or isolation techniques. An example mounting can include using cushioning blocks, such as rubber pads, arranged between the drive unit 120 and the power unit 110, with the rubber pads configured to absorb at least a portion of the vibrations and/or kickback from the drive unit 120.

Another mounting example can include using a rod and hole mounting system, whereby the power unit 110 and the drive unit 120 include aligned holes through which a rod, or rods, can be secured to attach the drive unit 120 to the power unit 110. The use of a rod system is preferable as it can be configured to allow a small or controlled degree of relative movement between the drive unit 120 and the power unit 110 in three planes. Transmission of vibration and kickback from the drive unit 120 to the power unit 110 can be further minimized through the use of rubber washers and spherical bearings. The holes of the rod system of the housing can include spherical bearings through which rods pass through, the spherical bearings allowing the rod limited motion relative to the power unit 110. Allowing limited motion of the drive unit 120 relative to the power unit 110 can absorb and minimize vibrations and/or kickback transmitted through the drive unit 120 to the user operating the trenching device 100.

For size and the power-to-weight ratio, the engine 121 of the example trenching device 100 of FIG. 1 is preferably a single cylinder, two-stroke engine, producing between 4-8 horsepower and having a maximum operating speed of 9,000-10,500 RPM. This engine style provides a sufficient power output while being compact and lightweight. The engine 121 is one of the heaviest components of the device 100 and minimizing the weight of the engine 121 is an important consideration for ease of use of the device 100 and minimization of user fatigue.

The engine 121 has sufficient power output to pull the trenching chain 152 though a desired substrate. In certain substrates, such as a loose soil, the power requirement can be low. However, in denser substrates, such as packed dirt or clay, and/or substrates that contain debris such as rocks, the power requirement can be high as more torque can be required to pull the trenching chain 152 through the substrate material.

In an alternative example embodiment, the engine 121 can be a small, lightweight four-stroke engine. The four-stroke engine is typically quieter than a two-stroke engine and does not require the oil-gas mixture to run on. Additionally, the four-stroke motor design has a more constant, or flatter, torque curve, providing a consistent level of torque across a wide range of operating speeds or engine RPMs. In some applications, it may be advantageous to power the trenching device 100 with the alternative four-stroke engine embodiment.

Alternative engines can be used with the trenching device 100, including smaller engine units, larger engine units and different types of engines. Alternative engine types can include electric, hydraulic and pneumatic motors that may be directly connected to a power source or include device mounted power supplies, such as batteries. The selection of the engine 121 of the device 100 can be determined by the operating conditions of the device 100.

Further, the engine 121 should be rated to operate consistently for extended periods of time at the desired RPM operating range. The continuous duty cycle of the engine 121 during use of the trenching device 100 requires that the engine 121 have sufficient operational abilities to withstand such a duty cycle. A lower RPM operating range can assist in withstanding the continuous duty cycle, the lower operating speeds reduces the likelihood of engine failure from overheating. An engine not rated for such continuous use, such as an engine designed for intermittent use at a higher RPM operating range, can have premature failure when used with the device 100. When selecting an appropriate power source, or engine 121, the operating specifications of the engine must be considered in view of the demands that will be imposed on it during use within the device 100.

The drive arm 122 transmits the engine 121 output to the trenching unit 150 and includes a housing 123, a first pulley 124, a second pulley 125, a driven shaft 126, a belt 127 and eccentric tensioner 128. The output of the engine 121 rotates an output shaft causing the first pulley 124 disposed thereon to rotate. The pulley 124 is engaged with the belt 127, which is in turn engaged with the second pulley 125. As the belt 127 is rotated by the first pulley 124, the second pulley 125 is also rotated, causing the driven shaft 126 to rotate. The driven shaft 126 includes a chain sprocket disposed opposite the second pulley 125, the rotation of the driven shaft 126 causing rotation of the engaged chain sprocket, causing rotation of the trenching chain 152. The pulley and belt arrangement is preferred as it further absorbs and dampens vibrations and kickback. Additionally, the belt drive system reduces shock loading to the engine 121, thereby eliminating the need for a shock absorbing element, such as shear bolts, to prevent damage to the engine 121.

The ratio of the diameter of the first pulley 124 to the diameter of the second pulley 125 is used to determine a “gear ratio” or “drive ratio” of the pulley system. The “drive ratio” determines the speed and torque at the driven shaft 126 based on the rotational speed and torque of the first pulley 124. The pulleys, 124 and 125, can be selected based on the desired power and speed transmission to the driven shaft 126. The pulleys, 124 and 125, can be interchangeable, allowing a user to effectively change the “gear ratio” as necessary or desired.

In an embodiment, the gear ratio can be 2 to 1, drive pulley to driven pulley. In the embodiment shown in FIG. 1, the output shaft of the engine is engaged with the first pulley 124, the driving pulley, which is rotated at approximately the same speed as the engine 121 output shaft. The belt 127 is rotated about the first pulley 124 and engaged with the second pulley 125, the driven pulley. The rotation of the belt 127 by the first pulley 124 causes rotation of the second pulley 125 and the driven shaft 126. Due to the drive ratio, for every two rotations of the first pulley 124, the second pulley 125 and driven shaft 126 are only rotated once. In this configuration the rotational speed of the engine is reduced by approximately half before the engagement with the trenching chain.

Proper chain speed is an important consideration when performing a trenching operation using the trenching device 100. The chain speed must be sufficient to allow for a continuous trenching operation, i.e. preventing the chain from bogging down or getting stuck in the substrate. Chain speed can also influence the amount of vibration experienced by the user. At higher speeds, the chain can skip or kickback when hitting obstructions rather than digging through or engaging the obstruction to move it. Also, at high chain speeds, imbalances within the chain can be magnified, further increasing overall vibration of the device 100 which can lead to increased user fatigue.

In the example trenching device 100 of FIG. 1, the belt 127 is an elastic serpentine belt. Alternative belt types can be used, such as a toothed or v-belt. The belt 127 is selected to efficiently and effectively transmit the power of the engine 121 from the drive or first pulley 124 to the driven or second pulley 125. The resilient nature of the elastic belt 127 allows the belt to absorb and minimize the transmission of vibrations and kickback that can arise while the trenching chain 152 is pulled through the substrate. Minimizing vibration and kickback reduces the fatigue and stress experienced by a user while operating the trenching device 100.

To maintain proper tensioning on the belt 127, the second pulley 125, includes an eccentric tensioner 128. Rotating the eccentric tensioner 128 about the driven shaft 126 causes the second pulley 125 to move, loosening or tightening the pulley 125 against the belt 127. Proper tension of the belt 127 is important for the overall efficiency of the power transfer from the belt 127 to the pulley 125. Alternative belt tensioning systems can be used, including a spring tensioning system or a sliding/telescoping drive arm 122 that can be adjusted by a set screw(s). The tensioning system can be arranged to further absorb and dampen vibration and kickback.

A drive arm housing 123 encloses the drive arm 122. In the example of FIG. 1, an external cover is shown removed for the sake of clarity. During operation, the drive arm 122 is enclosed and can feature a seal about its perimeter to further limit intrusion of moisture, dirt and other contamination within the drive arm housing 123. Preventing intrusion to the interior of the housing 123 assists in overall trenching device 100 efficiency by preventing unwanted debris from damaging the contained components and hampering rotation of the belt 127 and pulleys 124, 125 within the drive arm 122.

The first pulley 124 preferably includes a clutch disposed between the pulley 124 and the output of the engine 121. The use of a slip clutch can prevent damage to the engine and increase user safety. Additionally, a clutch can be included within the driven pulley 125 or connected to the driven shaft 126.

In an alternative embodiment, the belt drive system of the example of FIG. 1 can be a chain drive system. The chain drive system may be desirable for the more efficient power transmission and durability of a drive chain over a belt system. However, the chain drive system has some drawbacks in comparison to the preferred belt drive system. The chain drive requires regular lubrication of the chain and is often more difficult and expensive to replace than the belt of the belt drive system. Further, the chain drive more readily transmits vibration and/or device kickback to the user, which can increase user fatigue and decrease user safety.

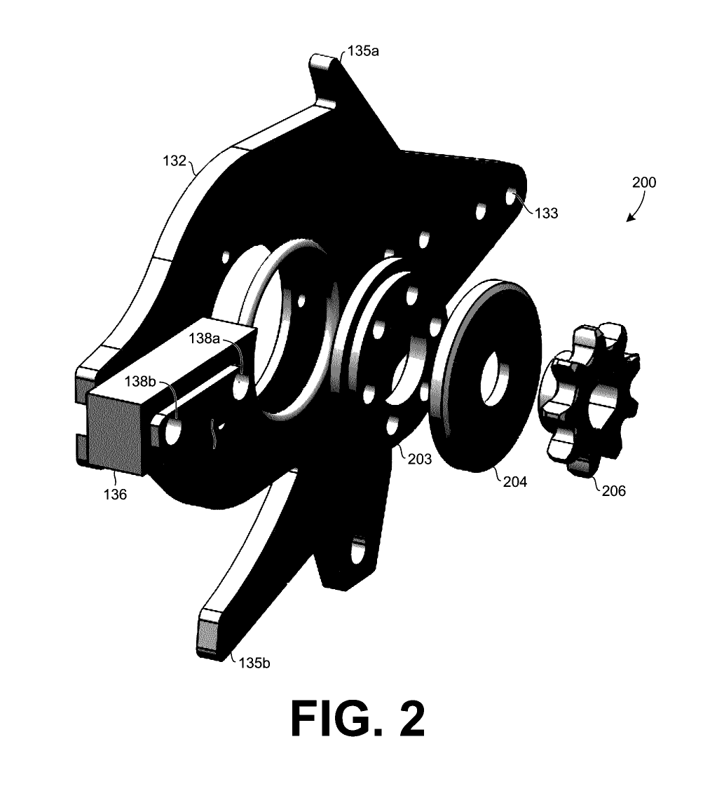

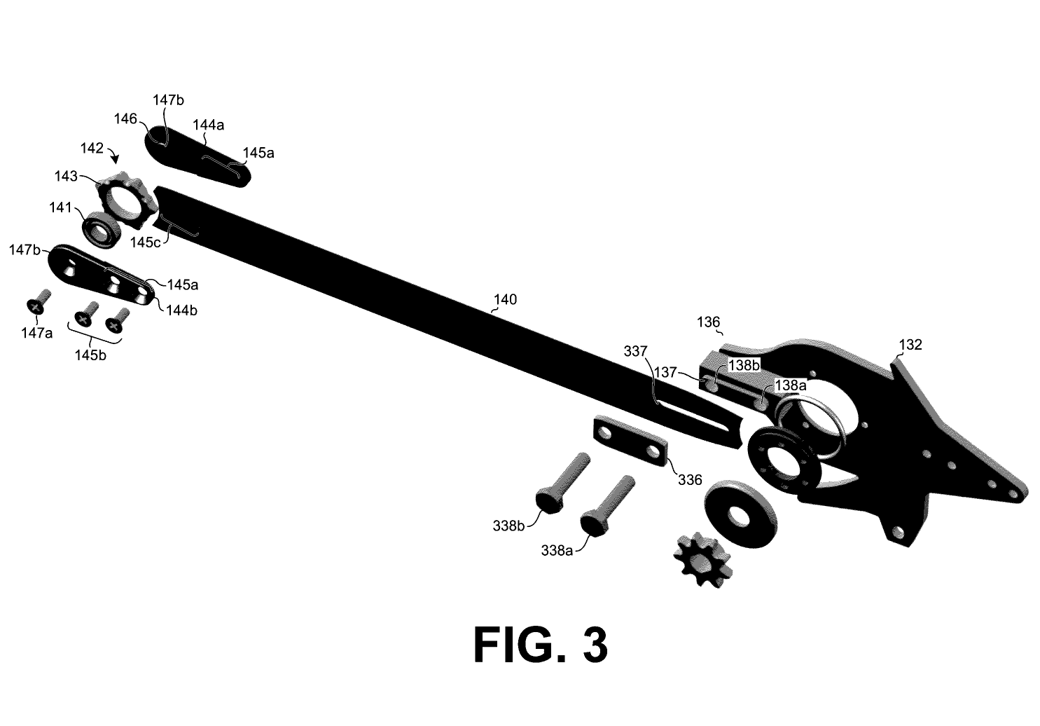

A mounting attachment 130 is directly affixed to the drive arm 122. The mounting attachment 130 includes the necessary hardware to affix the trenching unit 150 and trenching bar 140 to the drive unit 120. The mounting attachment 130 includes a mounting plate 132, a guard 134 and a trenching bar mounting block 136, as shown in FIGS. 2 and 3. The mounting plate 132 includes holes 133 disposed across its surface, through which screws can be passed to affix the plate 132 to the drive arm 122.

The mounting plate 132, shown in more detail in FIG. 2, provides a rigid plate to which the trenching unit 150 and trenching bar 140 are mounted. The mounting plate 132 can be constructed of metal, plastic or other suitable material, having a thickness, and/or other mechanical properties, sufficient for the required or desired rigidity of the plate 132. The plate can be formed using a cutting tool, such as a laser cutter or water jet, or injection molding process. Other suitable materials and manufacturing techniques can be used to form the plate 132.

A guard 134 can be affixed to the mounting plate 132 at mounting points 135a and 135b, shown in FIGS. 2 and 3. The guard 134 provides the user protection from loose substrate material that can be ejected during the trenching process. In the example trenching device 100 of FIG. 1, the guard 134 is flexible and constructed of a heavy rubber material. Alternatively, the guard 134 can be made of a rigid or other flexible material as desired or required. The selection of guard 134 material and/or geometry can be based at least in part on the substrate material the trenching device 100 will be used in.

A trenching bar mounting block 136 (shown in FIG. 2) is included, attached or mounted to, the mounting plate 132. The mounting block 136 provides the attachment point for the trenching bar 140 as shown in FIG. 3. The bar 140 is affixed to the mounting block 136 using a removable fastener such as a screw. It may be desirable for the trenching bar mounting block 136 to be removable from the mounting plate 132, so that it may be interchanged if necessary.

A trenching bar 140 supports the trenching chain 152 and can provide the necessary chain 152 tensioning system. The trenching bar 140 is preferably constructed of metal, for the strength and weight considerations. The trenching bar 140 can be treated and/or coated to increase its strength, hardness and/or durability. However, plastic or other suitable material can be used. A low friction material can also be disposed about the periphery of the trenching bar 140, to provide a low friction surface over which the chain 152 can be pulled. Such material can include a block, or blocks, of PTFE, disposed about the perimeter of the trenching bar 140. The width of the bar 140 is less than the width of the chain, but is suitably wide to adequately support the chain 152 and prevent it from twisting along a plane of travel.

A nose sprocket 142 guides the trenching chain 152 about the nose of the trenching device 100. The nose sprocket 142 is connected to the trenching bar 140 by a connector 144. The connector 144 spaces the nose sprocket 142 a distance from the end of the bar 140 to provide sufficient clearance for the teeth of the nose sprocket 142 as it rotates. In the embodiment shown in FIG. 1, the nose sprocket 142 lacks every other tooth. Alternatively, every other tooth of the nose sprocket can have a reduced profile. Rather than having a tooth to engage with each element of the trenching chain 152, the nose sprocket 142 engages every other chain element. In an alternative embodiment, the remaining every other tooth of the nose sprocket 142 can have a reduced profile, as shown in FIG. 3. The lack of alternate teeth, and/or the inclusion of alternate low profile teeth, assists in preventing dirt in the nose sprocket 142 from clogging with trenched substrate. A clogged nose sprocket 142 can bind with the chain 152 and/or cause the chain 152 to dislodge from the trenching device 100. The binding of the chain or dislodgement of the chain 152 from the device trenching 100 can cause an unsafe condition for the trenching device 100 and the user operating the trenching device 100.

A tensioning system or mechanism 146 can be included in the connector 144. The tensioning system 146 can tension the trenching chain 152. A tensioning system 146 can include a spring and set screw type tensioning system or other suitable chain 152 tensioning system or mechanism.

The excavation of substrate material to form a trench is performed by the trenching chain 152 and the attached trenching teeth 154. As the chain 152 is pulled, the teeth 154 engage the substrate material, separating and removing the substrate material to form a trench. The trench formed by the trenching device 100 will be approximately the width of the chain 152. The chain 152 can be interchanged to achieve a desired trench width.

The trenching teeth 154 are affixed to the trenching chain 152, in a pattern that alternates to each side of the chain. Additionally, the teeth 154 are spaced a number of chain elements apart from each other (e.g. three), as shown in FIG. 1, to prevent substrate material from lodging between the teeth, which can reduce the efficiency of the trenching device 100. The placement and orientation of the trenching teeth 154 along the trenching chain 152 can be altered for optimal trenching in a given substrate and/or for optimal wear and life span of the chain 152 and teeth 154.

The trenching teeth 154 can have a profile that can direct the excavated substrate material to a selected side of the trenching device 100 during a trenching operation. The profile of the teeth 154 can be optimized to place the excavated substrate material in a desired manner.

The trenching teeth 154 are constructed of a durable material, such as a high strength and durable metal. The teeth 154 are profiled and constructed such that they self-sharpen as the trenching chain 152 and the attached teeth 154 are pulled through the soil substrate. Should the teeth 154 dull, a user can run the trenching device 100 in an abrasive substrate in order to resharpen the teeth 154. Alternatively, the teeth 154 can be sharpened by hand or using a sharpening device.

Preferably, the selected tooth material can be sharpened and annealed or strengthened to hold a cutting edge 155. The use of such a material can allow the user to sharpen and/or hone the trenching teeth 154 regularly, as needed, to increase the overall efficiency of the trenching device 100 during a trenching operation. The trenching chain 152 and the trenching teeth 154 can be composed of the same or different materials that can be strengthened or hardened using various treatments and/or processes.

Additionally, the chain elements can undergo a coating process to further increase the strength, sharpness and/or durability of the cutting edge 155, teeth 154 and/or trenching chain 152. Example coatings can include coating to reduce the friction between elements and/or the substrate and deposition of durable coating material on wearing surfaces, such as those that engage the substrate, along with other types of desirable coating processes and materials.

In a further example, the teeth 154 may be removable from the chain 152, allowing the user to replace broken or worn teeth 154.

Inserts can be included on the trenching teeth 154, the inserts forming the cutting edge 155 of each tooth 154. The inserts can be made of a more durable material, such as carbide. The use of an insert made of a durable material means that rather than replacing a tooth or the whole chain 152, just the insert is required to be replaced as necessary. This can extend the life of the chain 152 as the inserts bear the brunt of the mechanical wear during a trenching operation.

The trenching bar 140 and trenching chain 152 form a trenching unit 150 that can be removed and mounted to the drive unit 120. The trenching bar 140 and trenching chain 152 can be changed to correspond to the desired depth of the formed trench, with a longer bar 140 and chain 152 combination used to form deeper trenches. This interchangeability allows the drive unit 120 and trenching assembly to be swapped as needed to achieve the desired trenching ability. Further, this modularity allows for the easy breakdown and transport of the device, and easy replacement of parts as a module or assembly. The modularity can also increase the efficiency of the production of the trenching device 100.

FIG. 2 is an example trenching chain mounting system 200. The system 200 includes an O-ring 202, an O-ring retainer 203, a labyrinth 204 and a drive sprocket 206, which are affixed to the driven shaft 126. The drive sprocket 206 engages and rotates the trenching chain 152 as the driven shaft 126 is rotated.

FIG. 3 is an exploded view of an example trenching chain mounting system and trenching bar. The trenching bar 140 is connected to the mounting plate 132 by the trenching bar mounting block 136. The trenching bar mounting block 136 includes a mounting boss 137 and holes 138a and 138b. The mounting boss 137 interfaces with a slot 337 of the trenching bar 140. The trenching bar 140 is affixed to the mounting block 136 using a trenching bar mounting plate 336 and screws, 338a and 338b, which are inserted into the holes 138a and 138b. The mounting boss 137 also prevents the trenching bar 140 from contacting the drive sprocket 206. When fastened, with a locknut, lock washer or other retaining method, the screws, 338a and 338b, exert pressure on the mounting plate 336 and, in turn, the trenching bar 140, securing the trenching bar 140 to the trenching bar mounting block 136.

In the example shown in FIG. 3, the slot 337 is longer than the boss 137, allowing the trenching bar 140 to be slid forward and back along the boss 137. The relative positioning between the boss 137 and the slot 337 allows the trenching bar 140 to extend from and retract towards the drive sprocket 206 and trenching device 100 to assist with tensioning the trenching chain 152 about the trenching bar 140. Additional chain tensioning methods and apparatuses can be used to tension the trenching chain about the trenching bar 140. Tensioning of the trenching chain 152 is important not only for safety, but also for the efficiency of the trenching chain 152 operation.

Preferably, the trenching chain 152 is run under-tensioned by an amount. Operating the trenching chain 152 in an under-tensioned state assists with clearing debris from the chain 152 and nose sprocket 142 without adversely affecting the efficiency and safety of the operation of the trenching device 100.

The nose sprocket 142 is attached to the trenching chain bar by a connector 144, which is composed of two halves 144a and 144b. Disposed between the two halves, 144a and 144b, is a nose sprocket bearing 141 with the nose sprocket 142 mounted thereon. The connector 144 is mounted to the trenching bar 140 such that the nose sprocket 142 is forward of the trenching bar 140 with clearance for the nose sprocket teeth 143 as the nose sprocket 142 is rotated.

The distance separating the nose sprocket 142 from an end of the trenching bar 140 is set by the geometry of the pattern of holes 145a disposed on the two halves, 144a and 144b, of the connector 144. Screws 145b are inserted through holes 145c of the trenching chain bar 140 and the holes 145a of the connector 144. The screws 145b are secured, preferably by locknuts, thereby joining the two halves, 144a and 144b, of the connector 144 to the trenching chain bar 140. Alternative fasteners and fastening methods can be used to affix the connector 144 to the trenching bar 140, such as rivets or threading of the holes 145a.

The nose sprocket 142, on the bearing 141, is connected to the connector 144 by a screw, or other fastener, 147a that is inserted through holes 147b of the two halves, 144a and 144b, and secured. The two halves, 144a and 144b, of the connector 144 include protrusions 146 that interface with an inner race of the bearing 141, securing the bearing 141 to the connector 144.

To form a trench, the trenching chain 152 of the trenching device 100 is placed in motion by a user, using the throttle control 119. The nose of the device 100 is placed against the substrate and guided to a desired trenching depth. Once the user has achieved the desired depth, the device 100 is guided along a pathway to form the desired trench.

As the trenching chain 152 and trenching teeth 154 are pulled through the substrate, the excavated substrate material is drawn to the surface and guided to a side of the forming trench by the profile of the trenching teeth 154 and the guard 134.

In an alternative example, the trenching device 100 can be mounted to a wheeled cart for the trenching operation. Attaching the device to a cart relieves the user from having to support the device 100. The cart can allow the user to guide the nose of the trenching device 100 to a desired trench depth. The user can then move the cart, with the attached device 100, along a desired pathway to form the trench.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A trenching device, comprising:
a power unit configured to rotate an output shaft at a first speed;
a drive unit coupled to the power unit and including a belt drive system configured to transmit power from the output shaft to a driven shaft, causing the driven shaft to rotate at a second speed; and
a trenching unit coupled to the drive unit, the driven shaft of the drive unit configured to rotate a continuous trenching chain about a trenching bar.

2. The trenching device of claim 1 wherein an operating speed of the power unit is configured to rotate the output shaft at the first speed of approximately 9500 revolutions per minute, the output shaft driving the driven shaft at a drive ratio of approximately 2 to 1 through the belt drive.

3. The trenching device of claim 1 wherein the belt drive system includes a driving pulley attached to the output shaft and a driven pulley attached to the driven shaft, the driving pulley and the driven pulley connected by a drive belt.

4. The trenching device of claim 3 wherein the driving pulley has a first diameter and the driven pulley has a second diameter, the ratio of the first diameter to the second diameter determining a drive ratio of the belt drive system.

5. The trenching device of claim 1 wherein the belt drive system includes a resilient drive belt configured to absorb vibrations transmitted through the drive unit.

6. The trenching device of claim 4 wherein the drive belt is at least one of a v belt, polygroove belt, ribbed belt, elastic belt and a timing belt.

7. The trenching device of claim 1 wherein the power unit includes an air intake filter including a foam filter element, a paper filter element, a gauze filter element and a felt filter element, the air intake filter configured to filter external air drawn into the power unit.

8. The trenching device of claim 1 wherein the air intake filter is configured to generate a cyclonic filtration action to filter external air drawn into the power unit.

9. The trenching device of claim 1 wherein the trenching unit includes a trenching bar about which the continuous trenching chain is driven by a drive sprocket affixed to the drive shaft.

10. The trenching device of claim 9 wherein the trenching bar includes a nose sprocket disposed on an end of the trenching bar opposite the drive sprocket and configured to guide the continuous trenching chain about the trenching bar, the nose sprocket including a plurality of teeth about the periphery of the sprocket, at least one of the plurality of teeth having a reduced profile.

11. The trenching device of claim 9 wherein the trenching bar includes a nose sprocket disposed on an end of the trenching bar opposite the drive sprocket and configured to guide the continuous trenching chain about the trenching bar, the nose sprocket teeth positioned to engage every other link of the continuous trenching chain, providing a gap between alternating links.

12. The trenching device of claim 11 wherein the nose sprocket teeth have a reduced profile.

13. The trenching device of claim 1 wherein the continuous trenching chain includes a plurality of trenching teeth configured to direct a majority of trenched material to a side of the formed trench.

14. The trenching device of claim 13 wherein the plurality of trenching teeth a hardened by a hardening process including at least one of a heat treatment and a coating process.

15. The trenching device of claim 1 wherein the trenching unit includes two continuous trenching chains driven parallel to one another.

16. The trenching device of claim 1 wherein the components are configured to be interchangeable.

17. The trenching device of claim 1 wherein the power unit includes at least one of a two stroke gasoline powered engine, a four-stroke gasoline powered engine and an electric motor.

18. The trenching device of claim 1 wherein the power unit and the drive unit include a concrete cutting saw engine and drive arm.
